(19) United States
(12) Patent Application Publication
(10) Pub. No.: US 2026/0088385 A1
(43) Pub. Date: Mar. 26, 2026

(54) Device and Method for Monitoring the Temperature of an Electrical Energy Storage Unit

(71) Applicant: Bayerische Motoren Werke Aktiengesellschaft, Muenchen (DE)

(72) Inventors: Bastian BEYFUSS, Muenchen (DE); Constantin GOLDENBERG, Muenchen (DE); Erich KAGLEDER, Piding (DE)

(21) Appl. No.: 19/109,257

(22) PCT Filed: Aug. 18, 2023
(86) PCT No.: PCT/EP2023/072760

§ 371 Date: Mar. 6, 2025

(30) Foreign Application Priority Data
Sep. 13, 2022 (DE) 10 2022 123 275.1

(51) Int. Cl. H01M 10/63; G01K 7/16; G01K 7/42; H01M 10/48

(52) U.S. Cl. CPC H01M 10/63; G01K 7/16; G01K 7/427; H01M 10/486; G01K 2217/00; H01M 2220/20

(57) ABSTRACT

A device and method for monitoring the temperature of an energy storage unit having M subsets of P storage cells, where M≥1 and/or P≥1, is provided. The P storage cells are arranged electrically in parallel with one another, and the M subsets are arranged electrically in series. The device is configured to determine M measured values of the impedance of the corresponding M subsets of P storage cells and to monitor the temperature of the energy storage unit based on the M measured values of the impedance.

### BACKGROUND AND SUMMARY

The present disclosure relates to an electrical energy store, e.g. for employment in a motor vehicle. In particular, the present disclosure relates to a method and to a corresponding device for monitoring the temperature of various storage cells of an electrical energy store.

An at least partially electrically powered vehicle comprises an energy store for the storage of electrical energy for the operation of an electric drive motor of the vehicle. The energy store typically comprises a plurality of individual storage cells, in particular a plurality of round cells, which are arranged in a housing of the energy store.

The service life and/or performance capability of an electrical energy store is/are typically dependent upon the temperature and/or the temperature management of individual storage cells of the energy store.

The present document addresses a technical object of enabling a particularly efficient and reliable temperature management of individual subsets of storage cells of an electrical energy store, particularly in order to increase the service life and/or performance capability of the energy store.

This object is fulfilled by aspects of the present disclosure. Advantageous embodiments are described, inter alia, in the present disclosure.

According to one aspect, a device is described for monitoring the temperature of an electrical energy store. The energy store can comprise M subsets of P storage cells respectively, wherein M≥1 and/or P≥1. Typical values for P lie between 2 and 6, and for M at 50 or more, or at 100 or more. The P storage cells can be electrically arranged in parallel with one another. The M subsets can be electrically arranged in series.

The energy store can assume a rated voltage of 60 V or more, or of 300 V or more, in particular of 800 V or more. The energy store can be designed to store electrical energy for the operation of a drive motor of a motor vehicle.

The energy store comprises R lines, each having Q rows of storage cells. In other words, the energy store can comprise a matrix of R×Q storage cells and/or storage cell locations. It is possible that R×Q=M×P. Lines can respectively extend along the longitudinal axis of the energy store, and rows can extend along the transverse axis of the energy store, wherein the transverse axis is arranged at right angles to the lateral axis. The longitudinal axis can correspond e.g. to the longitudinal axis of the vehicle in which the energy store is installed, and the transverse axis can correspond to the transverse axis of the vehicle.

In a preferred example, the R lines and Q rows of storage cell locations are respectively occupied by one storage cell. The energy store comprises a total of R*Q storage cells. As described hereinafter, however, it may be advantageous that sporadic storage cell locations are left unoccupied.

The respective storage cells can be cylindrical and/or the storage cells can be round cells. The storage cells can be arranged next to one another, such that storage cells respectively extend along the vertical axis of the energy store (which can correspond to the vertical axis of the vehicle in which the energy store is installed). The longitudinal axis, the transverse axis and the vertical axis can correspond to the axes of a cartesian coordinate system.

The storage cells and/or storage cell locations (i.e. the locations for the individual storage cells), can be arranged in a honeycomb pattern of R lines and Q rows. Three storage cells or storage cell locations can enclose one void. Moreover, six storage cells or storage cell locations can enclose one further storage cell or one further storage cell location.

The energy store can comprise a temperature control system for controlling temperature, in particular for cooling and/or heating. The temperature control system can comprise one or more temperature control lines, which are respectively routed e.g. between two directly adjoining lines of storage cells. A temperature control fluid can be conducted through the individual temperature control lines, in order to control the temperature of storage cells which adjoin the respective temperature control line.

The device can be designed to determine M measured values of the impedance of the corresponding M subsets of storage cells. The M measured values of (complex-valued) impedance can be determined for a specific measurement frequency. A measured value of impedance can comprise an actual component and a notional component.

The device can be designed to apply a measuring alternating current to the poles (in particular to the terminals) of the energy store. The measuring alternating current can assume the specific measurement frequency, a measuring amplitude and a measuring phase. Then, for each of the M subsets of storage cells, a measuring alternating voltage generated on the respective subsets of storage cells by the measuring alternating current can be captured, wherein the measuring alternating voltage assumes a measuring amplitude and a measuring phase.

The measured value of the impedance of the respective subset of storage cells can then be determined in an accurate manner on the basis of the measuring amplitude and the measuring phase of the measuring alternating current, and on the basis of the measuring amplitude and the measuring phase of the measuring alternating voltage.

The device is further designed to execute temperature monitoring of the energy store on the basis of the M measured values of impedance. The measured value of impedance can be employed as an indicator for the temperature value of the respective subset of storage cells. A particularly efficient and accurate monitoring of temperature can be enabled accordingly.

The device can also be designed to execute temperature monitoring on the basis of characteristic data (wherein characteristic data have typically been determined by experimentation (preliminary to the employment thereof in the device)). For a plurality of different temperature values of a subset of storage cells, characteristic data can respectively indicate a reference value for the impedance of the subset of storage cells. In other words, characteristic data can indicate a correlation between the impedance and temperature of a subset of storage cells. This correlation can be employed to determine estimated values for the temperature of individual subsets of storage cells in an efficient and accurate manner, and can be employed for monitoring the temperature of the energy store.

The device can be designed, by the employment of characteristic data and on the basis of M measured values of impedance, to determine a corresponding M estimated values of the temperature of the corresponding M subsets of storage cells. To this end, the device can be designed, for each of the M subsets of storage cells, to respectively determine a reference value from characteristic data which corresponds to the measured value of the impedance of the respective subset of storage cells. The estimated value of the temperature of the respective subset of storage cells can then be determined from characteristic data in an accurate manner, on the basis of the temperature value which is associated with the reference value thus determined (in particular, in the form of the temperature value which is associated with the reference value thus determined).

Moreover, the device can be designed to execute temperature monitoring of the energy store in a particularly accurate manner, on the basis of the M estimated temperature values of the corresponding M subsets of storage cells.

The device can be designed, on the basis of the M measured values of impedance, to identify a proportion of the M subsets of storage cells (e.g. on the basis of estimated temperature values determined) which assume a temperature which deviates from that of a complementary remainder (of the M subsets of storage cells). Alternatively, that proportion of the M subsets of storage cells which assume a measured value which deviates from that of the complementary remainder can be identified directly, by way of the identification of the corresponding proportion of the M subsets of storage cells which assume a temperature which deviates from that of the complementary remainder.

If one or more subsets of storage cells are identified which assume a temperature which deviates (significantly) from that of the complementary remainder, this can be indicative of a malfunction of the energy store, in particular of the temperature control system of the energy store. A measure (e.g. the output of an error message) can then be executed in order to counteract the malfunction.

The device can thus be designed, on the basis of the M measured values of impedance, to identify a proportion of the M subsets of storage cells which assume a measured value which deviates from that of the complementary remainder. To this end, on the basis of the M measured values of impedance, a mean value of or for the M measured values of impedance can be determined. The one or more subsets of storage cells can then be identified, the measured value of which deviates from the mean value by more than a predefined deviation value (e.g. by more than a specific percentage and/or by more than a specific absolute value), in order to identify that proportion of the M subsets of storage cells which assume a measured value which deviates from that of a complementary remainder.

As described above, a deviating measured value of impedance can be employed as an indicator of a deviating temperature. The device can thus be designed to determine that a technical problem is in force with respect to the temperature control of the identified proportion of the M subsets of storage cells.

The device can be designed e.g. to determine whether the spatial position of the identified proportion of the M subsets of storage cells (within the energy store) correlates to and, in particular, coincides with the spatial position of the one or more temperature control lines of the temperature control system for controlling the temperature of the energy store. It can moreover be determined that the temperature control system has a defect (e.g. has one or more at least partially obstructed temperature control lines), if it is established that the spatial position of the identified proportion of the M subsets of storage cells correlates to and, in particular coincides with the spatial position of one or more temperature control lines of the temperature control system.

An efficient and reliable monitoring of the temperature control system of the energy store can be executed accordingly.

The device can be designed to determine M frequency characteristics of the corresponding M subsets of storage cells. A frequency characteristic can respectively comprise a plurality of measured values of impedance for a corresponding plurality of measurement frequencies (e.g. for 5 or more, or 10 or more measurement frequencies). Temperature monitoring of the energy store can then be executed in a particularly accurate manner on the basis of the M frequency characteristics of impedance.

The device can be designed to determine M reference measured values of impedance of the corresponding M subsets of storage cells, in the event that the energy store assumes a reference state. The reference state can be a state e.g. in which the M subsets of storage cells assume the same temperature, or in which it can at least be assumed that the M subsets of storage cells assume the same temperature. This can be the case after a relatively prolonged downtime of the vehicle (in which the energy store is installed).

Optionally, the M reference measured values of impedance can be mutually distinguished on the grounds of differential ageing and/or on the grounds of manufacturing tolerances in the individual storage cells, notwithstanding the assumption of an equal temperature by the M subsets of storage cells.

The device can further be designed to determine M operating measured values of impedance for the corresponding M subsets of storage cells, where the energy store is in an operative state (in which temperature control of the energy store is currently in progress).

Temperature monitoring of the energy store in the operative state can then be executed in a particularly accurate manner on the basis of the M reference measured values and on the basis of the M operating measured values, in particular on the basis of a comparison of the M operating measured values with the corresponding M reference measured values. For example, to this end, M differential values for the corresponding M subsets of storage cells can be determined. A differential value can be determined on the basis of, or in the form of a difference of an operating measured value from a corresponding reference measured value.

The device can be designed, on the basis of the M differential values, to identify a proportion of the M subsets of storage cells which assume a differential value which deviates from that of a complementary remainder. To this end, on the basis of the M differential values, a mean value of or for the M differential values can be determined. The one or more subsets of storage cells can then be identified, the differential value of which deviates from the mean value by more than a predefined deviation value (e.g. by more than a specific percentage and/or by more than a specific absolute value), in order to identify that proportion of the M subsets of storage cells which assume a differential value which deviates from that of a complementary remainder. As described above, it can be determined that a technical problem is in force with respect to the temperature control of the identified proportion of the M subsets of storage cells.

According to a further aspect, a (road) motor vehicle (in particular a passenger car, or a heavy goods vehicle, or a bus, or a motorcycle) is described which comprises the device described in the present document for monitoring the temperature of an energy store of the vehicle.

According to a further aspect, a method is described for monitoring the temperature of an electrical energy store. The energy store can comprise M subsets of P storage cells respectively, wherein M≥1 and/or P≥1. The P storage cells can be electrically arranged in parallel with one another. Moreover, the M subsets can be electrically arranged in series.

The method comprises the determination of M measured values of the (complex-valued) impedance of the corresponding M subsets of storage cells. The method moreover comprises the execution of the temperature monitoring of the energy store on the basis of the M measured values of impedance.

According to a further aspect, a software (SW) program is described. The SW program can be designed to be run on a processor (e.g. on a control device of a vehicle) and thus to execute the method described in the present document.

According to a further aspect, a storage medium is described. The storage medium can comprise a SW program which is designed to be run on a processor, and thus to execute the method described in the present document.

It should be observed that the devices and systems described in the present document can be employed in isolation, or in combination with other devices and systems described in the present document. Moreover, any aspects of the devices and systems described in the present document can be mutually combined in a variety of ways. In particular, the features of the disclosure can be mutually combined in a variety of ways. Moreover, features described in brackets are to be understood as optional features.

Aspects of the present disclosure described in greater detail hereinafter with reference to exemplary embodiments.

### BRIEF DESCRIPTION OF THE DRAWINGS

FIG. 1 shows an exemplary vehicle having an energy store for storing electrical energy;

FIG. 2a shows an exemplary round cell;

FIG. 2b shows an exemplary electrical energy store having a plurality of round cells;

FIG. 3a shows an exemplary electrical energy store having a temperature control system;

FIG. 3b shows an equivalent circuit diagram of an electrical energy store;

FIG. 4 shows exemplary characteristic data for the correlation between the impedance and temperature of a storage cell or of a subset of storage cells; and

FIG. 5 shows a flow diagram of an exemplary method for monitoring the temperature of an electrical energy store.

### DETAILED DESCRIPTION OF THE DRAWINGS

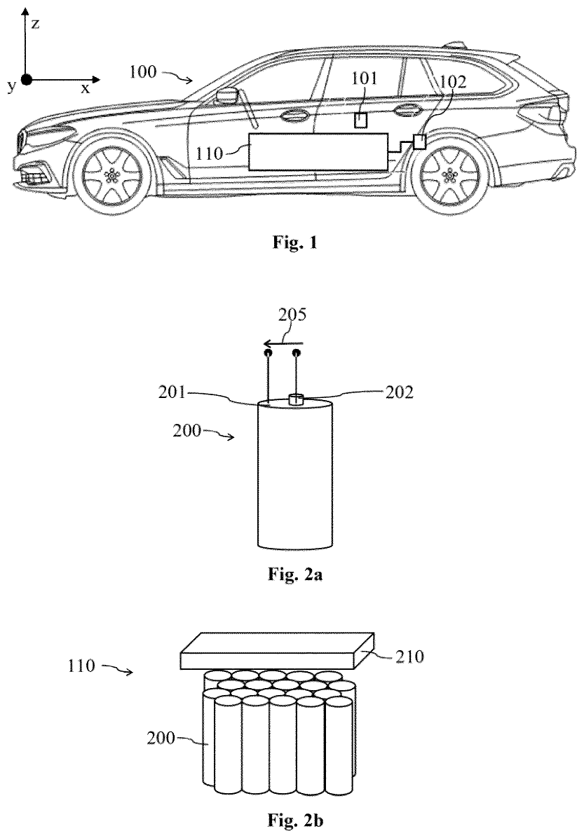

As described above, the present document addresses the efficient and reliable temperature monitoring of individual storage cells of an electrical energy store. In this connection, FIG. 1 shows an exemplary vehicle 100 having an electrical energy store 110 for storing electrical energy, and an electric drive motor 102 which is operated by electrical energy from the energy store 110. The energy store 110 is typically installed within a housing in the vehicle 100. The vehicle 100 can comprise a (control and/or monitoring) device 101 for the control and/or monitoring of the electrical energy store 110.

The energy store 110 comprises a plurality of storage cells, in particular of round cells. FIG. 2a shows an exemplary storage cell 200, in particular a round cell, for an electrical energy store 110. The storage cell 200 assumes a cylindrical form. On one end face of the storage cell 200, a positive contact point 201 and a negative contact point 202 for the electrical connection of the storage cell 200 are arranged. The positive contact point 201 can be formed by the end face of the cylindrical storage cell 200. The negative contact point 202 can be formed by a stud which projects from the end face of the storage cell 200. In a further example, the polarity of the contact points 201, 202 can be reversed.

Between the two contact points 201, 202 of the storage cell 200, a cell voltage 205 can be applied. This can be captured by an (unrepresented) measuring unit of the energy store 110. The energy store 110 can be designed to capture the cell voltage 205 of individual storage cells 200 and/or the cell voltage 205 of individual subsets of storage cells 200.

FIG. 2b shows an exemplary electrical energy store 110 which comprises a plurality of storage cells 200 which are contiguously arranged side-by-side (i.e. shell surface to shell surface), in particular such that the contact points 201, 202 of the individual storage cells 200 are arranged on a uniform side (in FIG. 2b, on the upper side). The energy store 110 can comprise e.g. 100 or more storage cells 200, or 1000 or more storage cells 200.

The individual storage cells 200 can be interconnected in an electrically conductive manner by a cell contact-connection system 210. The cell contact-connection system 210 can comprise e.g. a frame having connecting lines for the electrical contact-connection of the contact points 201, 202 of individual storage cells 200. The cell contact-connection system 210 can be arranged on the side of the storage cells 200 on which the contact points 201, 202 of the storage cells 200 are also arranged. On the opposing side of the storage cells 200, an (unrepresented) housing wall of a housing of the energy store 110 can be arranged. The opposing housing wall can be designed e.g. for cooling the individual storage cells 200.

As represented in FIG. 2b, the (cylindrical) storage cells 200 can be arranged such that the shell surfaces of directly adjoining storage cells 200 are in contact (wherein an electrically insulating layer can be arranged between the individual storage cells 200, in particular between storage cells 200 which are included in different subsets of storage cells 200). The storage cells 200 can be arranged next to one another in a honeycomb pattern, such that a respective subset of three storage cells 200 respectively encloses a void, and/or such that six respective storage cells 200 enclose one further storage cell 200. The (cylindrical) storage cells 200 can thus be configured in a particularly dense arrangement. In particular, the cylindrical storage cells 200 can be configured in an arrangement with the maximum possible packing density.

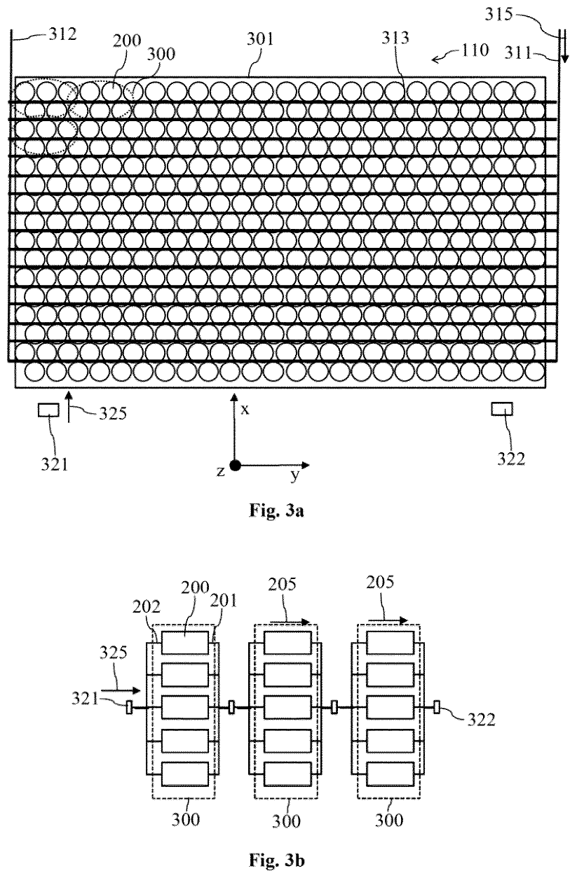

FIG. 3a shows an overhead view of an electrical energy store 110 which, in the example represented, comprises Q=24 columns or rows of storage cells 200 and R=16 lines of storage cells 200. The energy store 110 thus comprises 24×16 storage cells. In general, the electrical energy store 110 can comprise Q rows and R lines of storage cells 200, and thus Q×R storage cells 200. The energy store 110 is arranged in a housing 301. The energy store can comprise a first pole 321 (e.g. a positive pole) and a second pole 322 (e.g. a negative pole), which are respectively arranged e.g. on the housing 301.

The individual storage cells 200 of the energy store 110 can be arranged in a MP configuration i.e., in particular, M subsets 300 of P storage cells 200 respectively are electrically arranged in series between the two poles 321, 322. The P storage cells 200 of a subset 300 are electrically arranged in parallel with one another. In the example represented in FIG. 3a, P=5 storage cells 200 are interconnected in parallel. FIG. 3b shows the equivalent circuit diagram of the energy store 110 according to FIG. 3a wherein, in the interests of simplification, only M=3 series-connected subsets 300 of P=5 storage cells 200 respectively are represented in FIG. 3b.

The energy store 110 represented in FIG. 3a comprises a temperature control system for controlling the temperature, in particular for cooling or heating the individual storage cells 200. The temperature control system comprises a plurality of temperature control lines 313, which are routed between the individual storage cells 200. Each of the temperature control lines 313 preferably assumes an undulating or serpentine form, such that the individual temperature control lines 313 are at least intermittently routed along the shell surfaces of the individual round cells 200. The energy store 110, e.g. between two lines of storage cells 200, can respectively comprise one temperature control line 313 which is routed between the storage cells 200. Optionally, a temperature control line 313 can be provided on both sides of the individual storage cells 200 (and thus in each line). Alternatively, optionally, cooling of the individual storage cells 200 can be provided on one side only, such that a temperature control line 131 is only provided in every second line.

The temperature control system can further comprise a feeder 311, by which a temperature control fluid 315 (e.g. a liquid) can be conveyed to a first end of the individual temperature control lines 313. At the opposing second end of the individual temperature control lines 313, the temperature control fluid 315 can be evacuated from the energy store 110 by an outlet 312. It should be observed that the feeder 311 and the outlet 312 can be arranged on the same (first) side of the energy store 110. The respective temperature control lines 313 are mutually connected in pairs on the opposing (second) side and carry a flux which is alternately routed in opposing directions.

It can occur that an individual temperature control line 313 is (at least partially) obstructed, such that only a reduced quantity, or no temperature control fluid 315 whatsoever can be conveyed through this temperature control line 313. In consequence, the actual temperature of storage cells 200 which are arranged on this temperature control line 313 deviates from the target temperature for storage cells 200, thus potentially resulting in an impairment of the service life and/or performance capability of the energy store 110.

The provision of a plurality of temperature sensors for the corresponding plurality of storage cells 200 of an energy store 110 is typically associated with a relatively high degree of complexity, with respect to costs, structural space, reliability and/or weight.

The (control) device 101 can be designed to initiate for the M subsets of storage cells 200 of the energy store 110, the determination of a measured value of the impedance of the respective subset. To this end, a measuring alternating current 325 with a specific measurement frequency (which e.g. is superimposed with the direct current, e.g. the charging current or discharge current of the energy store 110) can be applied to the poles 321, 322 of the energy store 110. Accordingly, measured values for impedance can also be determined during the operation of the energy store 110 and/or of the vehicle 100. Thus, temperature monitoring can also be executed during operation.

Moreover, a measuring alternating voltage 205 can be captured for the individual subsets of storage cells 200, which is generated as a result of the measuring alternating current 325 applied to the contact points 201, 202 of the storage cells 200. On the basis of the measuring alternating voltage 205 (in particular the amplitude and phase thereof) and the measuring alternating current 315 (in particular the amplitude and phase thereof), a measured value of the (complex-valued) impedance of the respective subset 300 of storage cells 200 at a specific measurement frequency can be determined.

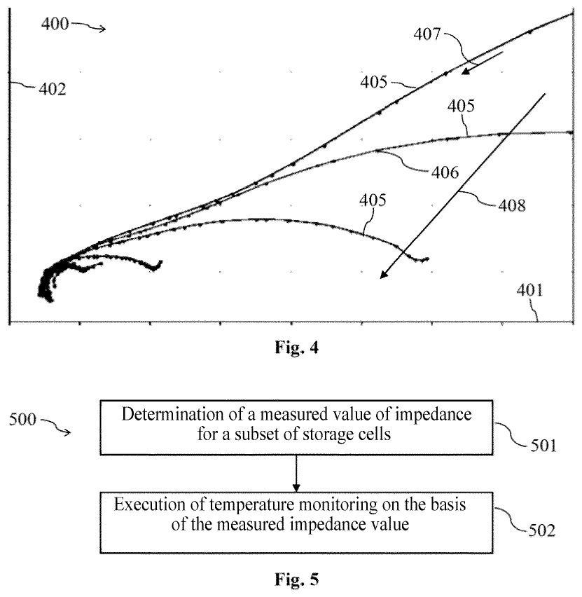

FIG. 4 shows exemplary characteristic data 400, which have been determined e.g. experimentally for the energy store 110. Characteristic data 400 comprise a plurality of reference values 406 for the impedance of a subset 300 of storage cells 200 of the energy store 110. Reference values 406 of impedance can thus be provided for a plurality of different temperatures 408 and/or for a plurality of different measurement frequencies 407. Individual reference values 406 for impedance respectively comprise an actual component 401 and a notional component 402.

In FIG. 4, various frequency characteristics 405 of the reference value 406 for the impedance of the subset 300 of storage cells 200 are represented for various temperatures 408. A frequency characteristic 405 respectively comprises a plurality of reference values 406 of impedance for a plurality of different measurement frequencies (e.g. for 5 or more or 10 or more). As can be seen from FIG. 4, the frequency characteristics 405 differ significantly from one another, particularly at relatively low temperatures 408 of 30° C. or lower. In consequence, the measured value of the impedance of a subset 300 of storage cells 200 can be employed as an indicator of the temperature value 408 of this subset 300 of storage cells 200.

The device 101 can thus be designed (during the operation of the energy store 110) to determine a measured value for the impedance of a specific subset 300 of storage cells 200 (for a specific measurement frequency). The measured value can then be compared with characteristic data 400, in order to determine an estimated value for the temperature 408 of this subset 300 of storage cells 200. To this end, reference values 406 of impedance for the specific measurement frequency 407 sourced from the characteristic data 400 can be considered. Different reference values 406 are associated with different values for temperature 408. The reference value 406 which corresponds to the measured value can then be identified (e.g. the reference value 406 which is closest to the measured value). The estimated value of the temperature 408 of the specific subset 300 of storage cells 200 can then be determined on the basis of, and in particular in the form of the value for temperature 408 which is associated with identified reference value 406.

Optionally, for the specific subset 300 of storage cells 200, a frequency characteristic of the measured value of impedance can be determined (e.g. for a sequence of different measurement frequencies). The frequency characteristic thus determined can be compared with reference characteristics 405 from the characteristic data 400, in order to identify one or more reference characteristics 405 which most closely match the frequency characteristic thus determined. The estimated value of the temperature 408 of the specific subset 300 of storage cells 200 can then be identified in a particularly accurate manner on the basis of values for temperature 408 which are associated with the one or more reference characteristics 405 identified.

In a corresponding manner, an estimated value for temperature 408 can be determined for each of the M subsets 300 of the energy store 110. Monitoring of the temperature of the individual storage cells 200 of the energy store 110 can thus be executed in a simple and reliable manner (without the necessity for the employment of dedicated temperature sensors for this purpose).

Thus, for the M subsets 300 of the energy store 110, measured values for impedance, in particular for the frequency characteristics of impedance, can be determined. The M measured values and/or the M frequency characteristics can be analyzed, in order to detect any impairment of the temperature control system of the energy store 110. In particular, it can be detected that a proportion of the M measured values and/or frequency characteristics deviates significantly from the remaining measured values and/or frequency characteristics (which is an indicator to the effect that the corresponding proportion of the M subsets 300 assumes a significantly different temperature 408).

A check can be executed as to whether the identified proportion of subsets 300 of storage cells 200 is arranged along a temperature control line 313 or otherwise. If so, it can be concluded that this temperature control line 313 is compromised and, in particular, is obstructed. Servicing of the temperature control system can then be initiated (e.g. by the output of an instruction for the attention of a user of the energy store 110).

The above-mentioned comparison can be executed in a corresponding manner on the basis of the estimated values for temperature 408 determined for the M subsets 300. A proportion of the subsets 300 of storage cells 200 can be identified which assume an estimated value which deviates significantly from the estimated values for temperature 408 of the remaining subsets 300.

As described above, temperature management of the high-voltage store 110 is particularly important for an electric vehicle 100. The operating temperature of the high-voltage store 110 influences its service life, its performance capability and/or its self-discharge rate. Battery cooling by a temperature control system ensures that the (typically lithium-ion) battery 110 is maintained within an optimum target temperature range. On very hot or on very cold days, the battery 110 of an electric vehicle 100 is therefore cooled or warmed. In the interests of functional battery cooling, the coolant 315 flows in the corresponding cooling ducts 313 in a substantially evenly distributed manner. Cell voltages and/or temperatures can be continuously monitored by a monitoring electronic circuit (a “cell supervision circuit” or “CSC”for short). Thermal behavior can be characterized by temperature sensors.

In the present document, a monitoring system and/or a diagnostic method for cooling ducts 315 is/are described, for which no temperature sensors are required. The monitoring system 101 and/or the diagnostic method 500 employ(s) electrical impedance spectroscopy (EIS), which is applied to individual subsets 300 of storage cells 200.

For the indirect determination of the cell temperature 408, the alternating current resistance (i.e. the impedance) of individual subsets 300 of storage cells 200 of the vehicle battery 110 can be measured. In response to a specific alternating current excitation 325 (with respect to frequency and amplitude), the voltage response 205 of the individual subsets 300 of storage cells 200 is measured. On the basis thereof, a respective measured value of impedance can be calculated.

In the context of a measurement program, an impedance spectrum can be calculated by way of characteristic data 400, wherein it has been demonstrated that the impedance spectrum shows a relatively high temperature sensitivity (in particular for temperatures below 30° C.). On the basis of characteristic data 400, the individual cooling hoses 313, e.g. during a heat-up phase of the battery 110, can undergo diagnosis and/or monitoring (for obstruction).

FIG. 5 shows a flow diagram of an (optionally computer-implemented) method 500 for the temperature monitoring of an electrical energy store 110. The energy store 110 can comprise M subsets of P storage cells respectively, wherein M≥1 and/or P≥1. The P storage cells are electrically arranged in parallel with one another, and the M subsets are electrically arranged in series. Typical values for P range from 2 to 6. Typical values for M are 50 or more, or 100 or more, or 200 or more.

The method 500 comprises the determination 501 of M measured values of the impedance of the corresponding M subsets 300 of storage cells 200. Individual measured values can respectively comprise an actual component 401 and a notional component 402 of impedance. The M measured values of impedance can be respectively determined for one or more measurement frequencies.

The method 500 further comprises the execution 502 of temperature monitoring of the energy store 110 on the basis of the M measured values of impedance. The M measured values of impedance can respectively be employed as indicators for the temperature 408 of the corresponding M subsets 300 of storage cells 200 (optionally by the employment of characteristic data 400 which describe a relationship between impedance and temperature 408).

The measures described in the present document permit an efficient an accurate temperature measurement of individual storage cells 200 or of individual subsets 300 of storage cells 200 (even without the employment of a temperature sensor). The measures described can be implemented with no additional complexity of hardware.

The present disclosure is not limited to the exemplary embodiments disclosed. In particular, it should be observed that the description and the figures are only intended to serve as an exemplary illustration of the principle of the methods, devices and systems proposed.

1-11. (canceled)

12. A device for monitoring a temperature of an electrical energy store which comprises M subsets of P storage cells respectively, wherein M≥1 and/or P≥1, wherein the P storage cells are electrically arranged in parallel with one another, wherein the M subsets are electrically arranged in series, and wherein the device is configured to:
determine M measured values of impedance corresponding to each of the M subsets of P storage cells; and
execute temperature monitoring of the electrical energy store based on the M measured values of the impedance.

13. The device according to claim 12, wherein the device is configured to execute the temperature monitoring based on characteristic data,
wherein the characteristic data for a plurality of different temperature values of a subset of P storage cells respectively indicate a reference value for the impedance of the subset of P storage cells, and
wherein the characteristic data have been determined by experimentation.

14. The device according to claim 13, wherein the device is configured to:
determine, using the characteristic data and based on the M measured values of the impedance, M estimated values of the temperature corresponding to the M subsets of P storage cells; and
execute the temperature monitoring of the electrical energy store based on the M estimated values of the temperature corresponding to the M subsets of P storage cells.

15. The device according to claim 13, wherein the device is configured to:
determine, for each respective subset of P storage cells from among the M subsets of P storage cells, the reference value from the characteristic data corresponding to the measured value of the impedance of the respective subset of P storage cells; and
determine, for each of the M subsets of P storage cells, an estimated value of the temperature of the respective subset of P storage cells based on a temperature value from the characteristic data which is associated with the reference value thus determined.

16. The device according to claim 12, wherein the device is configured to:
identify a proportion of the M subsets of P storage cells, based on the M measured values of the impedance, which assume a measured value which deviates from that of a complementary remainder; and
determine that a technical problem is in force with respect to temperature control of the identified proportion of the M subsets of P storage cells.

17. The device according to claim 16, wherein the device is configured to identify the proportion of the M subsets of P storage cells which assume the measured value which deviates from that of the complementary remainder by:
determining a mean value of the M measured values of the impedance based on the M measured values of the impedance; and
identifying one or more subsets of storage cells, the measured value of which deviates from the mean value by more than a predefined deviation value.

18. The device according to claim 16, wherein the device is configured to:
determine whether a spatial position of the identified proportion of the M subsets of P storage cells correlates to and coincides with the spatial position of one or more temperature control lines of a temperature control system for controlling the temperature of the electrical energy store; and
determine that the temperature control system and/or the one or more temperature control lines of the temperature control system have a defect based on it being established that the spatial position of the identified proportion of the M subsets of P storage cells correlates to and coincides with the spatial position of the one or more temperature control lines of the temperature control system.

19. The device according to claim 12, wherein the device is configured to:
apply a measuring alternating current to poles of the electrical energy store,
wherein the measuring alternating current assumes a measurement frequency, a first measuring amplitude and a first measuring phase, and
wherein for each respective subset of P storage cells from among the M subsets of P storage cells:
a measuring alternating voltage generated on the respective subset of P storage cells by the measuring alternating current is captured;
the measuring alternating voltage assumes a second measuring amplitude and a second measuring phase; and
the measured value of the impedance of the respective subset of P storage cells is determined based on the first measuring amplitude and the first measuring phase of the measuring alternating current and the second measuring amplitude and the second measuring phase of the measuring alternating voltage.

20. The device according to claim 12, wherein the device is configured to:
determine M frequency characteristics of the impedance corresponding to the M subsets of P storage cells, wherein a frequency characteristic respectively comprises a plurality of measured values of the impedance for a corresponding plurality of measurement frequencies; and
execute the temperature monitoring of the electrical energy store based on the M frequency characteristics of the impedance.

21. The device according to claim 12, wherein the device is configured to:
determine M reference measured values of the impedance corresponding to the M subsets of P storage cells based on the electrical energy store assuming a reference state;
determine M operating measured values of the impedance corresponding to the M subsets of P storage cells, wherein the electrical energy store is in an operative state; and
execute the temperature monitoring of the electrical energy store in the operative state based on the M reference measured values and the M operating measured values based on a comparison of the M operating measured values with the M reference measured values.

22. A method for monitoring a temperature of an electrical energy store which comprises M subsets of P storage cells respectively, wherein M≥1 and/or P≥1, wherein the P storage cells are electrically arranged in parallel with one another, wherein the M subsets are electrically arranged in series, and wherein the method comprises:
determining M measured values of impedance corresponding to each of the M subsets of P storage cells; and
executing temperature monitoring of the electrical energy store based on the M measured values of the impedance.

23. The method according to claim 22, further comprising:
executing the temperature monitoring based on characteristic data,
wherein the characteristic data for a plurality of different temperature values of a subset of P storage cells respectively indicate a reference value for the impedance of the subset of P storage cells, and
wherein the characteristic data have been determined by experimentation.

24. The method according to claim 23, further comprising:
determining, using the characteristic data and based on the M measured values of the impedance, M estimated values of the temperature corresponding to the M subsets of P storage cells; and
executing the temperature monitoring of the electrical energy store based on the M estimated values of the temperature corresponding to the M subsets of P storage cells.

25. The method according to claim 23, further comprising:
determining, for each respective subset of P storage cells from among the M subsets of P storage cells, the reference value from the characteristic data corresponding to the measured value of the impedance of the respective subset of P storage cells from among the M subsets of P storage cells; and
determining, for each of the M subsets of P storage cells, an estimated value of the temperature of the respective subset of P storage cells, based on a temperature value from the characteristic data which is associated with the reference value thus determined.

26. The method according to claim 22, further comprising:
identifying a proportion of the M subsets of P storage cells, based on the M measured values of the impedance, which assume a measured value which deviates from that of a complementary remainder; and
determining that a technical problem is in force with respect to temperature control of the identified proportion of the M subsets of P storage cells.

27. The method according to claim 26, wherein identifying the proportion of the M subsets of P storage cells which assume the measured value which deviates from that of the complementary remainder comprises:
determining a mean value of the M measured values of the impedance based on the M measured values of the impedance; and
identifying one or more subsets of storage cells, the measured value of which deviates from the mean value by more than a predefined deviation value.

28. The method according to claim 26, further comprising:
determining whether a spatial position of the identified proportion of the M subsets of P storage cells correlates to and coincides with the spatial position of one or more temperature control lines of a temperature control system for controlling the temperature of the electrical energy store; and
determining that the temperature control system and/or the one or more temperature control lines of the temperature control system have a defect based on it being established that the spatial position of the identified proportion of the M subsets of P storage cells correlates to and coincides with the spatial position of the one or more temperature control lines of the temperature control system.

29. The method according to claim 22, further comprising:
applying a measuring alternating current to poles of the electrical energy store, wherein the measuring alternating current assumes a measurement frequency, a first measuring amplitude and a first measuring phase;
for each respective subset of P storage cells from among the M subsets of P storage cells, capturing a measuring alternating voltage generated on the respective subset of P storage cells by the measuring alternating current, wherein each measuring alternating voltage assumes a second measuring amplitude and a second measuring phase; and
determining the measured value of the impedance of each respective subset of P storage cells based on the first measuring amplitude and the first measuring phase of the measuring alternating current and based on each second measuring amplitude and each second measuring phase of the measuring alternating voltage.

30. The method according to claim 22, further comprising:
determining M frequency characteristics of the impedance corresponding to the M subsets of P storage cells, wherein a frequency characteristic respectively comprises a plurality of measured values of the impedance for a corresponding plurality of measurement frequencies; and
executing the temperature monitoring of the electrical energy store based on the M frequency characteristics of the impedance.

31. The method according to claim 22, further comprising:
determining M reference measured values of the impedance corresponding to the M subsets of P storage cells based on the electrical energy store assuming a reference state;
determining M operating measured values of the impedance corresponding to the M subsets of P storage cells, where the electrical energy store is in an operative state; and
executing the temperature monitoring of the electrical energy store in the operative state based on the M reference measured values and based on the M operating measured values based on a comparison of the M operating measured values with the M reference measured values.
